(19) United States
(12) Patent Application Publication
(10) Pub. No.: US 2023/0185342 A1
(43) Pub. Date: Jun. 15, 2023

(54) WINDOW, METHOD FOR MANUFACTURING WINDOW, AND DISPLAY DEVICE INCLUDING THE WINDOW

(71) Applicant: Samsung Display Co., LTD., Yongin-si (KR)

(72) Inventors: Min-Hoon CHOI, Seoul (KR); Seung Ho KIM, Asan-si (KR); Yu Ri KIM, Guri-si (KR); Seong Jin HWANG, Suwon-si (KR); Kyung-Man KIM, Anyang-si (KR); Byung Hoon KANG, Seoul (KR); Sang Hoon KIM, Hwaseong-si (KR); Sung Hoon KIM, Hwaseong-si (KR)

(21) Appl. No.: 17/974,622

(22) Filed: Oct. 27, 2022

(30) Foreign Application Priority Data
Dec. 14, 2021 (KR) 10-2021-0178587

(51) Int. Cl. G06F 1/16

(52) U.S. Cl. CPC G06F 1/1656

(57) ABSTRACT

A window includes a body unit in which a plurality of grooves is defined, and a width of a groove of the plurality of grooves in a first direction which is parallel to a main extension direction of the body unit is about 80 micrometers (μm) to about 100 μm.

This application claims priority to Korean Patent Application No. 10-2021-0178587, filed on Dec. 14, 2021, and all the benefits accruing therefrom under 35 U.S.C. § 119, the content of which in its entirety is herein incorporated by reference.

### BACKGROUND

### (a) Field

Embodiments of the invention relate to a window, a method for manufacturing a window, and a display device including the window.

### (b) Description of the Related Art

With a recent development of display related technologies, display devices which may be deformable in use, such as being folded, rolled in a roll form, and stretched like a rubber band, are being researched and developed. The flexible display device may be changed in various forms, and therefore may satisfy both a demand for a large-size display and a demand for a small-size display for portability in use.

### SUMMARY OF THE INVENTION

As a stress that is greater than a breaking strength by excessive bending or repetitive stress caused by repetitive bending is applied to the flexible display device, the lifespan of the display device is reduced, and parts and wires may be damaged.

Further, the flexible display device is thin for the purpose of its bending, and in this case, impact resistance may be reduced and the parts may be easily damaged.

Embodiments of the invention has been made in an effort to provide a window for improving impact resistance performance and a display device including the same.

An embodiment of the invention provides a window including a body unit in which a plurality of grooves disposed is defined. A width of a groove of the plurality of grooves in a first direction which is parallel to a main extension direction of the body unit is about 80 micrometers (μm) to about 100 μm.

In an embodiment, a thickness of the body unit overlapping a lowest side of the groove in a second direction perpendicular to the first direction may be about 25 μm to about 40 μm.

In an embodiment, a ratio of a thickness of the body unit overlapping a lowest side of the groove to an entire thickness of the window may be about 13 percent (%) to about 50%.

In an embodiment, a distance between adjacent grooves of among the plurality of grooves in the first direction may be about 100 μm to about 200 μm.

In an embodiment, a compressed stress of the surface of the window may be about 200 megapascals (MPa) to about 800 MPa when a reinforced layer having a thickness of about 4 micrometers to about 80 micrometers is disposed on the surface of the window.

In an embodiment, the groove may be defined in a first side of the body unit, the groove may be defined in a side that is compressed when bent, or the groove may be defined in a side that is tensioned when bent.

In an embodiment, the plurality of grooves may include a first groove defined in a first side of the body unit and a second groove defined in a second side of the body unit, and the first groove and the second groove may be alternately defined.

In an embodiment, the first groove and the second groove may have different widths in the first direction.

In an embodiment, a width at an entrance of the groove in the first direction may be less than a width in the groove in the first direction.

In an embodiment, a width at an entrance of the groove in the first direction may be greater than a width in the groove in the first direction.

Another embodiment of the invention provides a display device including a display panel including a bending area and a bending peripheral area, and a window disposed on a first side of the display panel. The window includes a body unit in which a plurality of grooves is defined. The plurality of grooves is disposed in the bending area, and a width of a groove of the plurality of grooves in a first direction which is parallel to a main extension direction of the body unit is about 80 μm to about 100 μm.

In an embodiment, a thickness of the body unit overlapping a lowest side of the groove in a second direction perpendicular to the first direction may be about 25 μm to about 40 μm.

In an embodiment, a ratio of a thickness of the body unit overlapping a lowest side of the groove to an entire thickness of the window may be about 13% to about 50%.

In an embodiment, a distance among the plurality of grooves in the first direction may be about 100 μm to about 200 μm.

In an embodiment, the display device may further include a reinforced layer disposed on a surface of the window, a thickness of the reinforced layer may be about 4 μm to about 80 and a compressed stress of the surface of the window may be 200 MPa to 800 MPa.

In an embodiment, the groove may be defined in a first side of the body unit, the groove may be defined in a side that is compressed when bent, or the groove may be defined in a side that is tensioned when bent.

In an embodiment, the plurality of grooves may include a first groove defined in a first side of the body unit and a second groove defined in a second side of the body unit, and the first groove and the second groove may be alternately defined.

In an embodiment, a length of the bending area may be greater than a product of pi (π) and a curvature radius of the display device by equal to or greater than about 1 millimeter (mm).

Another embodiment of the invention provides a method for manufacturing a window. The method includes defining a groove by etching the window, and additionally etching the window in which the groove is defined. A thickness of the window etched in the additionally etching is about 0.1 μm to about 5 μm.

In an embodiment, a width of the groove in a first direction which is parallel to a main extension direction of the window may be about 80 μm to about 100 μm.

By the embodiments, the window with improved impact performance and the display device including the same are provided.

### BRIEF DESCRIPTION OF THE DRAWINGS

The above and other exemplary embodiments, advantages and features of this disclosure will become more apparent by describing in further detail exemplary embodiments thereof with reference to the accompanying drawings, in which:

FIG. 1 shows a cross-sectional view of an embodiment of a window and a display device including the window.

FIG. 2 and FIG. 3 show an embodiment of a window of a display device.

FIG. 4 shows an embodiment in which a window shown in FIG. 2 is bent.

FIG. 5 shows a window in which a groove is defined.

FIG. 6 shows a window and a pen when pen dropping is evaluated.

FIG. 7 shows that fine defects are generated in a groove of a window before over-healing.

FIG. 8 shows a window from which defects are removed through over-healing.

FIG. 9 shows an impact resistance improving effect with respect to a thickness Off etched by over-healing.

FIG. 10 shows results of measuring impact resistance with respect to a first length t₁ of a groove.

FIG. 11 shows results of measuring impact resistance while changing Gr.

FIG. 12 shows impact resistance with respect to a thickness t₂ of a body unit disposed below a groove.

FIG. 13 shows results of measuring impact resistance while changing Pr.

FIG. 14 shows results of measuring impact resistance while changing a third length t₃.

FIG. 15 to FIG. 20 show windows with various shapes of grooves.

FIG. 21 shows a window including a bending area and bending peripheral area.

FIG. 22 shows a pen drop testing method.

FIG. 23 shows a 2PB test.

FIG. 24 shows compressed stresses with respect to thickness, regarding a window with a thickness of a reinforced layer as about 5.4 micrometers (μm) and a compressed stress of a surface as about 677.54 megapascals (MPa).

FIG. 25 shows an embodiment of a display device including a window and a reinforced layer disposed on the window.

### DETAILED DESCRIPTION

Embodiments of the invention will be described more fully hereinafter with reference to the accompanying drawings, in which embodiments of the invention are shown. As those skilled in the art would realize, the described embodiments may be modified in various different ways, all without departing from the spirit or scope of the invention.

Parts that are irrelevant to the description will be omitted to clearly describe the invention, and the same elements will be designated by the same reference numerals throughout the specification.

Parts that are irrelevant to the description are omitted to clearly describe the disclosure, and like reference numerals designate like elements throughout the specification. In the drawings, the thickness of layers, films, panels, regions, etc., are enlarged for clarity. For ease of description, the thicknesses of some layers and areas are exaggerated.

It will be understood that when an element such as a layer, film, region, or substrate is referred to as being “on” another element, it can be directly on the other element or intervening elements may also be present. In contrast, when an element is referred to as being “directly on” another element, there are no intervening elements present. The word “on” or “above” means disposed on or below the object portion, and does not necessarily mean disposed on the upper side of the object portion based on a gravitational direction.

Unless explicitly described to the contrary, the word “comprise” and variations such as “comprises” or “comprising” will be understood to imply the inclusion of stated elements but not the exclusion of any other elements.

The phrase “in a plan view” means viewing a target portion from the top, and the phrase “in a cross-sectional view” means viewing a cross-section formed by vertically cutting a target portion from the side.

A cover window and a display device including the same in an embodiment will now be described in detail with reference to accompanying drawings.

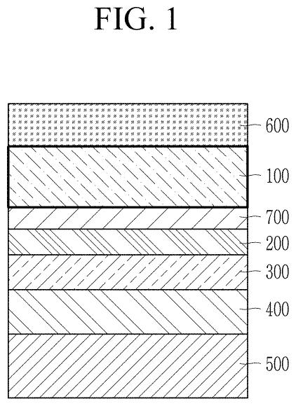

FIG. 1 shows a cross-sectional view of an embodiment of a window and a display device including the window. Referring to FIG. 1, the window 100 may be disposed on a first side of the display panel 200.

The display panel 200 may include a plurality of transistors and light-emitting devices connected thereto. In an embodiment, a thickness of the display panel 200 in a thickness direction (e.g., vertical direction in FIG. 1) may be about 20 micrometers (μm) to about 50 μm. That is, the thickness direction may be perpendicular to a main plane extension direction (e.g., horizontal direction in FIG. 1) of the display panel 200. The display panel 200 and the window 100 may be attached to each other by an adhesive layer 700. The adhesive layer 700 may be at least one of a pressure sensitive adhesive (“PSA”), an optically clear adhesive (“OCA”), and an optically clear resin (“OCR”). A thickness of the adhesive layer 700 in the thickness direction may be about 20 μm to about 60 μm.

A protection layer 600 may be disposed on a second side of the window 100. The protection layer 600 may protect the window 100 from external impacts, and may prevent or minimize generation of scratches on an upper side of the window 100. The protection layer 600 may include a polymer resin. The invention is not limited thereto, and the protection layer 600 may include an inorganic material. A thickness of the protection layer in the thickness direction may be about 40 μm to about 120 μm.

A protection member 300 may be disposed on a second side of the display panel 200. The protection member 300 may be disposed on a lower portion of the display panel 200, may support the display panel 200, and may protect the display panel 200 from external impacts. The protection member 300 may include a polymer resin such as a polyethylene terephthalate or a polyimide. A thickness of the protection member 300 in the thickness direction may be about 30 μm to about 80 μm.

A support member 400 may be disposed on a first side of the protection member 300. The support member 400 may be disposed on a lower portion of the display panel 200 to support the display panel 200 and protect the display panel 200 from external impacts. The support member 400 may include a polymer resin such as a polyethylene terephthalate or a polyimide. A thickness of the support member 400 in the thickness direction may be about 30 μm to about 90 μm.

A plate 500 may be disposed on a lower portion of the support member 400. Although not shown, the plate 500 may include a bending area and a bending peripheral area, and a groove may be defined in the bending area. The plate 500 may include a metal, or may be configured with a stacked structure of reinforced plastic. A thickness of the plate 500 in the thickness direction may be about 100 μm to about 500 μm.

The display device in the illustrated embodiment may be a foldable display device that is bent or folded. Regarding the display device in the illustrated embodiment, the window 100 may include a groove defined in the bending area, and hence, the display device may be easily bent.

In detail, the foldable display device may include a set cover for receiving the display panel. The set cover may include a first set cover and a second set cover that are separated from each other, and a hinge cover for connecting the first set cover and the second set cover. The display device may be folded and unfolded with respect to the hinge cover. The hinge cover may have flexibility. The hinge cover may overlap the bending area of the window 100.

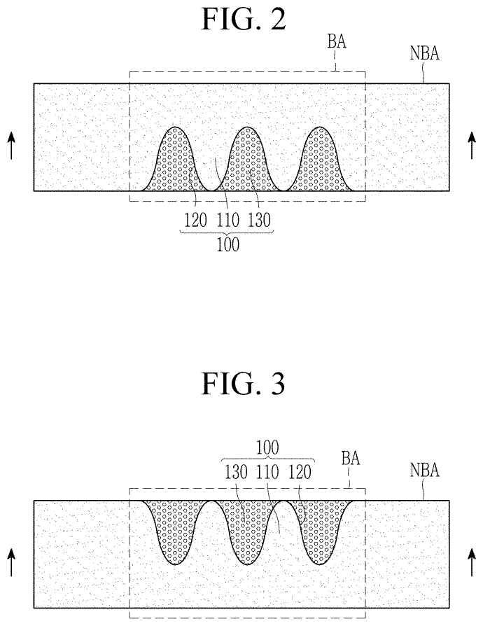

The window 100 of the display device will now be described in detail. FIG. 2 and FIG. 3 show an embodiment of a window 100 of a display device. Referring to FIG. 2, the window 100 of the display device in the illustrated embodiment may include a body unit 110 in which a groove 120 is defined, and an elastic layer 130 filling the groove 120.

The body unit 110 may include glass or plastic. The elastic layer 130 may include a polymer material. The elastic layer 130 may be transparent, and a refractive index difference with the body unit 110 may be less than about 10 percent (%). Therefore, a boundary of the body unit 110 and the elastic layer 130 may not be seen in the window 100.

As shown in FIG. 2, the window 100 may include a bending area BA and a bending peripheral area NBA, and the groove 120 may be defined in the bending area BA. However, this is an embodiment, and the groove 120 may be defined in the bending area BA and the bending peripheral area NBA of the window 100.

In FIG. 2, the bending direction is marked with an arrow. In this instance, the groove 120 may be defined in an opposite direction of a bending direction, that is, it may be defined in a side where a tension stress is generated in the case of a bending. A detailed shape and size of the groove 120 will be described in a later part of the specification.

The window of FIG. 3 has an opposite defining direction of the groove 120 to the window 100 of FIG. 2. That is, in FIG. 3, the bending direction is marked with the arrow, and the groove 120 may be defined in the bending direction, that is, it may be defined in a side where a compressed stress is generated in the case of bending.

That is, referring to FIG. 2 and FIG. 3, the defining direction of the groove 120 from among the window 100 may be the bending direction or the opposite bending direction. In any case, the stress (tension, compression) generated in the case of bending is spread by the groove 120 so the bending may be efficiently performed.

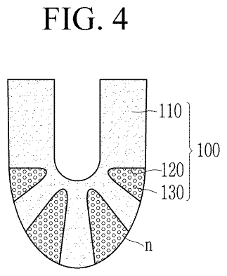

FIG. 4 shows a case in which a window 100 in an embodiment shown in FIG. 2 is bent. Referring to FIG. 4, the window 100 may be bent by the groove 120 and the elastic layer 130 filling the groove 120 in the case of bending. The tension stress in the case of bending is spread by the groove 120 and the elastic layer 130.

The groove 120 of the window 100 has a size, a gap, and a depth of the groove 120 for maximizing impact resistance. Detailed numerical values of the groove 120 will now be described with effects.

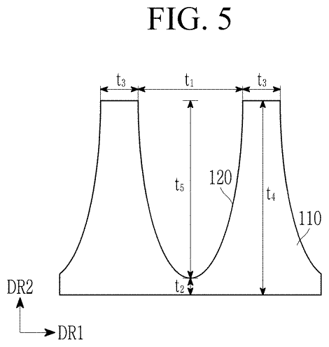

FIG. 5 shows a window 100 in which a groove 120 is defined. FIG. 5 shows a body unit 110 and a groove 120 of the window 100.

A width of the groove 120 in the first direction DR1 is set to be a first length t₁, and a depth of the groove 120 in the second direction DR2 is set to be a fifth length t₅. A thickness of the body unit 110 in the second direction DR2 is set to be a fourth length t₄, a thickness of the body unit 110 overlapping the lowest end of the groove 120 is set to be a second length t₂, and a distance between the neighboring groove 120 in the first direction DR1 is set to be a third length t₃.

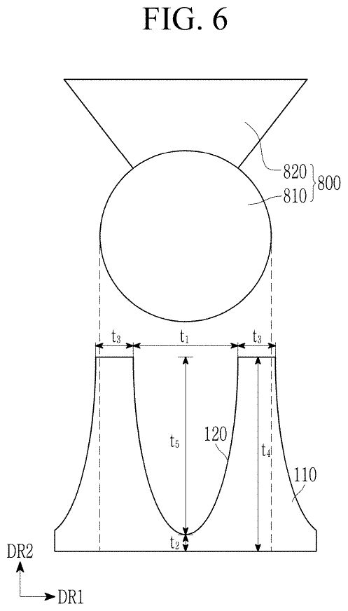

FIG. 6 shows a window 100 and a pen 800 when pen dropping is estimated. The pen 800 includes a tip 810 and a body 820. The tip 810 may have a circular shape. The tip 810 may have a diameter of about 0.3 millimeter (mm).

Referring to FIG. 6, a region of the window 100 overlapping the tip 810 is marked with dotted lines. A volume of the window 100 overlapping the tip 810 will be also referred to as Gt. That is, when the diameter of the tip is set to be about 0.3 mm, Gt becomes 0.3n×t₄. Here, a ratio of the volume (Ga) of the body unit 110 from among Gt will be also referred to as Gr. That is, Gr is defined to be Ga/Gt. Gr is a total volume (Ga)/0.3π×t₄ (Gt) of the body unit 110 disposed in the dotted lines.

The groove of the window 100 may be defined by irradiation of laser beams and an etching process. First, a laser influenced region may be formed by irradiating laser beams to the window. The region to which laser beams are irradiated is a region in which a groove will be defined. The region of the window 100 to which laser beams are irradiated may have an etching selecting ratio that is different from that of the region to which no laser beams are irradiated. That is, by irradiating the laser beams, the region of the window 100 to which laser beams are irradiated may be well etched.

The window 100 to which laser beams are irradiated is etched. The region to which laser beams are irradiated has a greater etching selecting ratio than the region to which no laser beams are irradiated, so it may be further well etched. Hence, the groove 120 is defined in the region to which laser beams are irradiated by the etching ratio difference.

In the process for defining the groove 120 of the window 100, the fine defects on the surface may be removed through over-healing after a pattern of the groove 120 is defined. By performing the over-healing, an impact resistance improving effect of the window 100 may be generated. The over-healing represents additionally etching the window 100 after defining the groove 120. The impact resistance improving effect caused by the over-healing and an appropriate thickness will now be described.

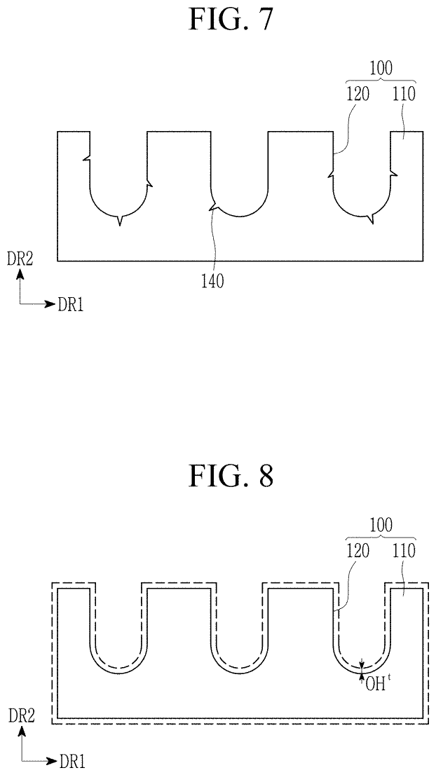

FIG. 7 shows that fine defects 140 are defined in a groove 120 of a window 100 before over-healing. As shown in FIG. 7, fine defects 140 may be generated on the surface in the process for defining the groove 120. The fine defects 140 may become a point where cracks start when an impact is applied to the window 100, and the cracks may be progressed from the fine defects 140.

FIG. 8 shows a window 100 from which fine defects 140 are removed through over-healing. FIG. 8 shows a thickness OH′ etched by the over-healing. As shown in FIG. 8, the thickness of the window 100 is generally reduced by the over-healing, and the region in which the fine defects 140 are disposed is also etched. Therefore, the fine defects 140 are removed from the over-healed window 100, and impact resistance of the window 100 may be increased.

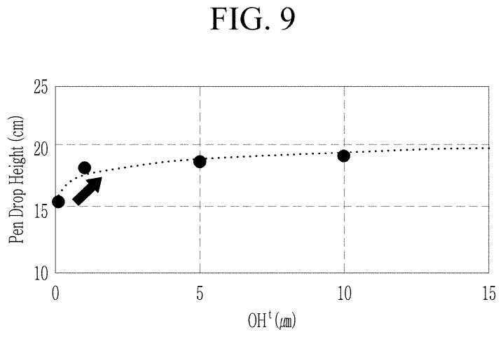

FIG. 9 shows an impact resistance improving effect with respect to a thickness Off etched by over-healing. Referring to FIG. 9, impact resistance is tested through the pen drop test while changing the thickness Off etched by the over-healing. Referring to FIG. 9 and subsequent drawings, the numerical values of the pen drop test are measured heights at which the cracks are generated when the pen with a tip 810 of about 0.3 mm is dropped, signifying that impact resistance is stronger as the height increases.

Referring to FIG. 9, it is found that as long as the thickness Off etched by the over-healing is equal to or greater than about 0.1 μm, the impact resistance is improved regardless of an additionally etched amount.

In an embodiment, the thickness Off etched by the over-healing may be 0.1 μm<OH^{t}<5 μm, for example. When the over-healing etching thickness Off is less than about 0.1 μm, the fine defects 140 may be insufficiently removed and the impact resistance may not be improved. When the over-healing etching thickness Off is greater than about 5 μm, the groove 120 may be substantially etched, which is undesirable.

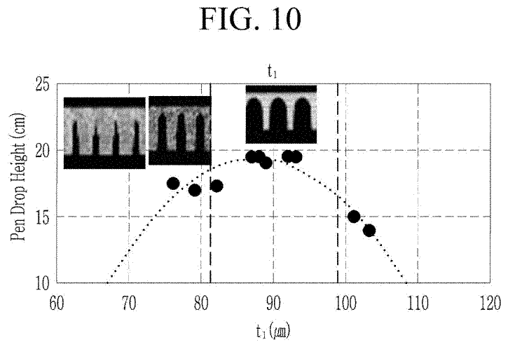

Referring to FIG. 5, the first length t₁ that is the width of the groove 120 in the first direction DR1 may be 80 μm<t₁<100 μm. This corresponds to the numerical range optimized to the impact resistance of the window 100. FIG. 10 shows results of measuring impact resistance with respect to a first length t₁ of a groove 120. Referring to FIG. 10, when the first length t₁ is less than about 80 μm, processability becomes weak, which is disadvantageous in the impact resistance. That is, as shown in FIG. 10, the width of the groove 120 becomes substantially small, so the groove 120 may not be stably processed, which may reduce the impact resistance.

Referring to FIG. 10, when the first length t₁ is greater than about 100 μm, the impact resistance is reduced. This is because, when the width of the groove is greater than about 100 μm, a support region of the window 100 is reduced, which is disadvantageous in the impact resistance. That is, as shown in FIG. 10, as the region of the portion occupied by the groove 120 from among the window 100 increases, the support region from among the window 100 is reduced, which may reduce the impact resistance.

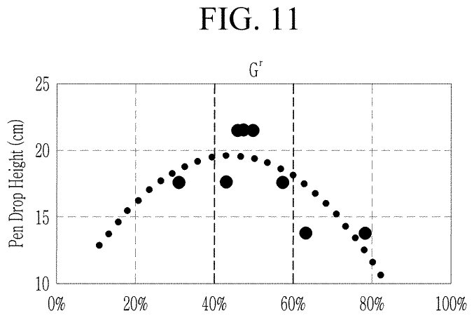

In FIG. 6, the optimal range of Gr may be about 40% to about 60%. As described above, Gr represents a ratio of the volume (Ga) of the body unit 110 from among the volume (Gt) of the window 100 overlapping the tip 810. FIG. 11 shows results of measuring impact resistance while changing Gr. Referring to FIG. 11, it is found that, when Gr is about 40% to about 60%, impact resistance is excellent. This is because, in a like way of what is described with reference to FIG. 10, when Gr is less than about 40%, the support region of the window 100 is reduced, which is disadvantageous in the impact resistance. This is because, when Gr is greater than about 60%, the support area of the window 100 increases, but processability is weak in the actual process, which is disadvantageous in the impact resistance.

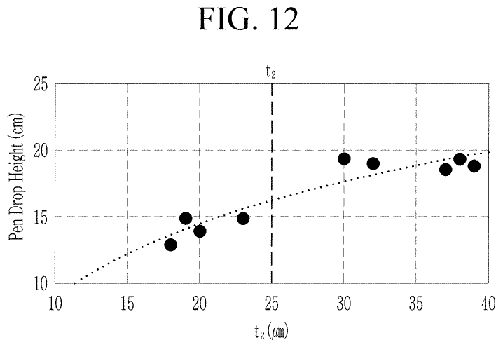

Referring to FIG. 5, the second length t₂ that is the thickness of the body unit 110 overlapping the lowest end of the groove 120 may be 25 μm<t₂<40 μm. FIG. 12 shows impact resistance with respect to a thickness t₂ of a body unit 110 disposed below a groove 120. Referring to FIG. 12, it is found that, when the second length t₂ is greater than about 25 μm, impact resistance is improved. This is because, when the body unit 110 on the lower portion of the groove 120 is thin, the impact is insufficiently absorbed. It may be advantageous in the impact resistance as the thickness of the second length t₂ increases, but it may give an influence to flexibility when the second length t₂ is greater than about 40 μm. That is, when the thickness t₂ of the body unit 110 on the lower portion of the groove 120 is greater than about 40 μm, 1.5R folding is impossible, so it is not preferable for the thickness t₂ of the body unit 110 on the lower portion of the groove 120 to be greater than about 40 μm.

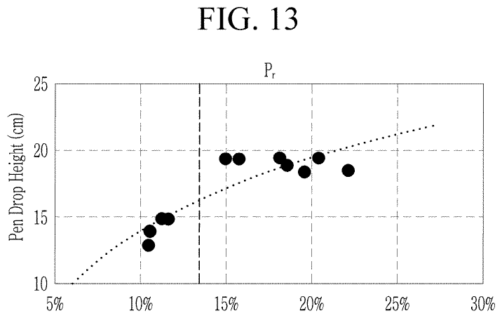

In FIG. 5, Pr is defined to be t₂/t₄. That is, Pr is given as the second length t₂ that is the thickness of the body unit 110 overlapping the lowest end of the groove 120/the fourth length t₄ that is the thickness of the body unit 110 in the second direction DR2. FIG. 13 shows results of measuring impact resistance while changing Pr. Referring to FIG. 13, it is found that, when Pr is greater than about 13%, the impact resistance is improved. This is because, when the body unit 110 on the lower portion of the groove 120 is thin in a like way of what is described with reference to FIG. 12, the impact is insufficiently absorbed. Here, Pr may be about 13% to about 50%. When Pr is less than about 13%, the body unit 110 is thin and may not absorb the impact, and when Pr is greater than about 50%, the body unit 110 becomes thick, which may give an influence to the flexibility.

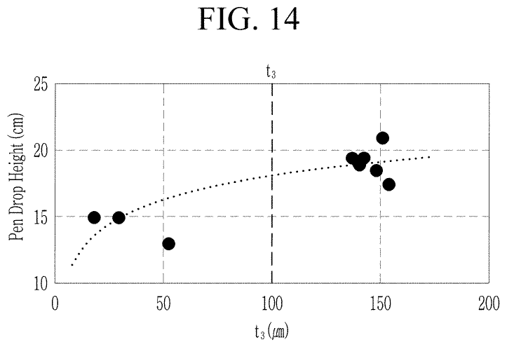

In FIG. 5, the third length t₃ that is a distance of the body unit 110 disposed between the neighboring groove 120 in the first direction DR1 may be about 100 μm to about 200 μm. FIG. 14 shows results of measuring impact resistance while changing a third length t₃. Referring to FIG. 14, it is found that, when the third length t₃ is equal to or greater than about 100 μm, the impact resistance is increased. When the third length t₃ is less than about 100 μm, the support region becomes small, which is disadvantageous in the impact resistance. When the third length t₃ is greater than about 200 μm, the width of the groove 120 is reduced, so processability may have a problem, which may deteriorate the impact resistance. When the third length t₃ is greater than about 200 μm, the influence of the groove 120 may be reduced in the window 100, and a stress spreading effect by the groove 120 may be insufficient.

An embodiment in which the shape of the groove 120 is disposed on one side as shown in FIG. 5 and FIG. 6, and the shape and the position of the groove 120 may be variable.

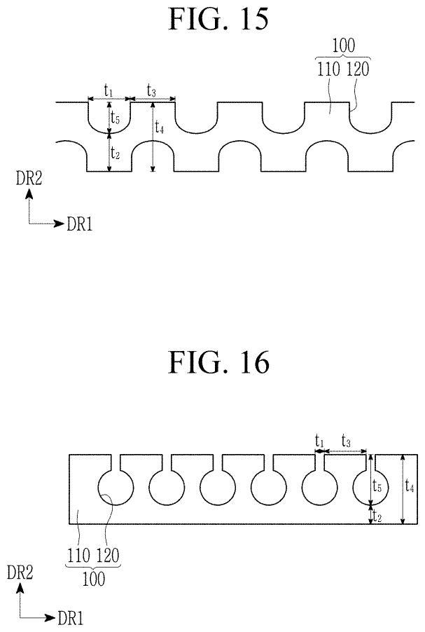

FIG. 15 to FIG. 20 show windows 100 with various shapes of a groove 120. Referring to FIG. 15, the groove 120 in the illustrated embodiment may be alternately disposed on respective sides of the window 100. That is, the groove 120 is defined in one side of the window 100 in FIG. 5 and FIG. 6, and the groove 120 may be defined in respective sides of the window in FIG. 15.

A first length t₁, a second length t₂, a third length t₃, a fourth length t₄, and a fifth length t₅ are as shown in the window 100 of FIG. 15. That is, a width of the groove 120 in the first direction DR1 is marked as the first length t₁, a depth of the groove 120 in the second direction DR2 is marked as the fifth length t₅, a thickness of the body unit 110 in the second direction DR2 is marked as the fourth length t₄, a thickness of the body unit 110 overlapping the lowest end of the groove 120 is marked as the second length t₂, and a distance between the neighboring groove 120 in the first direction DR1 is marked as the third length t₃.

The first length t₁, the second length t₂, the third length t₃, the fourth length t₄, and the fifth length t₅ of the window 100 of FIG. 15 may have the above-described numerical range. That is, regarding the window 100 of FIG. 15, the first length t₁ may satisfy 80 μm<t₁<100 the second length t₂ may be 25 μm<t₂<40 Pr(t₂/t₄) may be about 13% to about 50%, and the third length t₃ may be about 100 μm to about 200 Further, Gr(Ga/Gt) may be about 40% to about 60%.

FIG. 16 shows a window 100. Referring to FIG. 16, regarding the window 100 in the illustrated embodiment, the groove 120 has a shape in which an entrance is narrow and an inner side is wide. The first length t₁, the second length t₂, the third length t₃, the fourth length t₄, and the fifth length t₅ are as shown in an embodiment of FIG. 16. The first length t₁, the second length t₂, the third length t₃, the fourth length t₄, and the fifth length t₅ of the window 100 of FIG. 16 may have the above-described range. That is, regarding the window 100 of FIG. 16, the first length t₁ may satisfy 80 μm<t₁<100 μm, the second length t₂ may be 25 μm<t₂<40 μm, Pr(t₂/t₄) may be about 13% to about 50%, and the third length t₃ may be about 100 μm to about 200 μm. Further, Gr(Ga/Gt) may be about 40% to about 60%.

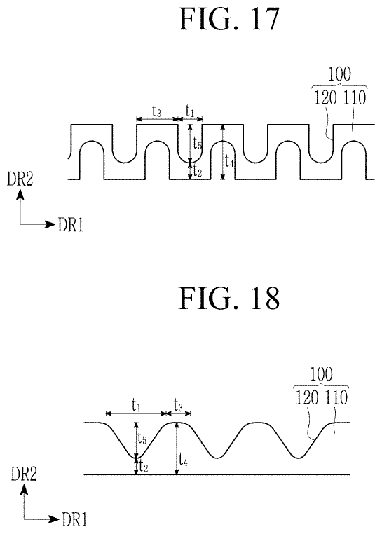

FIG. 17 shows a window 100. Referring to FIG. 17, regarding the window 100 in the illustrated embodiment, the groove 120 may be alternately defined in respective sides of the window 100. The first length t₁, the second length t₂, the third length t₃, the fourth length t₄, and the fifth length t₅ are as shown in an embodiment of FIG. 17. The first length t₁, the second length t₂, the third length t₃, the fourth length t₄, and the fifth length t₅ of the window 100 of FIG. 17 may have the above-described range. That is, regarding the window 100 of FIG. 17, the first length t₁ may satisfy 80 μm<t₁<100 μm, the second length t₂ may be 25 μm<t₂<40 μm, Pr(t₂/t₄) may be about 13% to about 50%, and the third length t₃ may be about 100 μm to about 200 μm. Further, Gr(Ga/Gt) may be about 40% to about 60%.

FIG. 18 shows another embodiment of a window 100. Referring to FIG. 18, regarding the window 100 in the illustrated embodiment, the groove 120 may have a shape that is similar to a triangle. The first length t₁, the second length t₂, the third length t₃, the fourth length t₄, and the fifth length t₅ are as shown in an embodiment of FIG. 18. The first length t₁, the second length t₂, the third length t₃, the fourth length t₄, and the fifth length T5 of the window 100 of FIG. 18 may have the above-described range. That is, regarding the window 100 of FIG. 18, the first length t₁ may satisfy 80 μm<t₁<100 μm, the second length t₂ may be 25 μm<t₂<40 μm, Pr(t₂/t₄) may be about 13% to about 50%, and the third length t₃ may be about 100 μm to about 200 μm. Further, Gr(Ga/Gt) may be about 40% to about 60%.

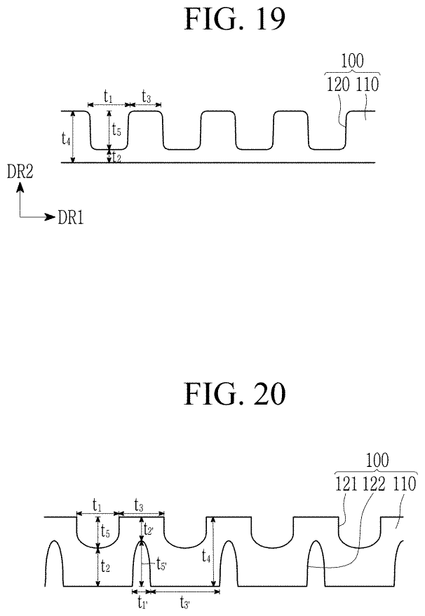

FIG. 19 shows another embodiment of a window 100. Referring to FIG. 19, regarding the window 100 in the illustrated embodiment, the groove 120 may have a shape that is similar to a quadrangle. The first length t₁, the second length t₂, the third length t₂, the fourth length t₄, and the fifth length t₅ are as shown in an embodiment of FIG. 19. The first length t₁, the second length t₂, the third length t₂, the fourth length t₄, and the fifth length t₅ of the window 100 of FIG. 19 may have the above-described range. That is, regarding the window 100 of FIG. 19, the first length t₁ may satisfy 80 μm<t₁<100 μm, the second length t₂ may be 25 μm<t₂<40 μm, Pr(t₂/t₄) may be about 13% to about 50%, and the third length t₃ may be about 100 μm to about 200 μm. Further, Gr(Ga/Gt) may be about 40% to about 60%.

FIG. 20 shows a window 100. Referring to FIG. 20, regarding the window 100 in the illustrated embodiment, the first groove 121 defined in a first side and the second groove 122 defined in a second side may have different sizes. That is, the first length t₁ of the first groove 121 may be different from the first length (t₁′) of the second groove 122, and the second length t₂ of the first groove 121 may be different from the second length (t₂′) of the second groove 122. In a like way, that is, the third length t₃ of the first groove 121 may be different from the third length (t₃′) of the second groove 122, and the fifth length t₅ of the first groove 121 may be different from the fifth length (t₅′) of the second groove 122.

In this case, regarding the window 100 of FIG. 20, the first length t₁ of the first groove 121 may satisfy 80 μm<t₁<100 μm, the second length t₂ may be 25 μm<t₂<40 μm, Pr(t₂/t₄) may be about 13% to about 50%, and the third length t₃ may be about 100 μm to about 200 μm. The first length (t₁′) of the second groove 122 may satisfy 80 μm<t₁′<100 μm, the second length (t₂′) may be 25 μm<t₂′<40 μm, Pr′(t₂′/t₄′) may be about 13% to about 50%, and the third length (t₃′) may be about 100 μm to about 200 μm.

The window 100 with various shapes of the groove 120 has been described with reference to FIG. 15 to FIG. 20, which is an example, and is not limited thereto. The groove 120 and the window 100 may have various shapes.

The window in the illustrated embodiment may include a bending area BA and a bending peripheral area NBA, and a groove 120 may be defined in the bending peripheral area NBA.

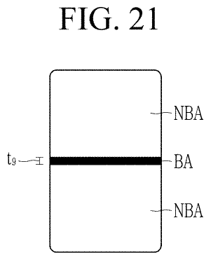

FIG. 21 shows a window including a bending area BA and bending peripheral area NBA. A minimum length t₉ of the bending area BA in which the groove is defined may be (π×curvature radius (R))+1 mm. That is, when a curvature radius of the foldable display device is given as R, a length of the region in which the groove 120 is defined must be greater than πt by equal to or greater than about 1 mm. In this case, the bending may be stably performed.

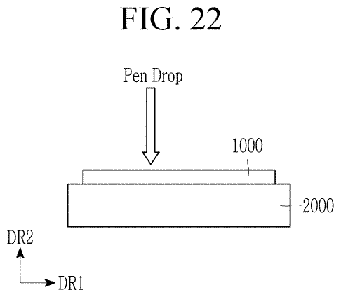

The window 100 in which the groove 120 with the above-described size is defined may not be broken at the height of about 10 centimeters (cm) when a pen drop test is performed. FIG. 22 shows a pen drop testing method. As shown in FIG. 22, the display device 1000 is disposed on a base plate 2000, and the pen 800 shown in FIG. 6 is dropped to perform a test. The pen 800 used in this case may have the weight of 5.8 gram (g) and the diameter of about 0.3 mm.

In the case of the ball drop test by which the ball with the weight of 5.6 g and the diameter of about 11.1 mm, the window 100 with the groove 120 in the illustrated embodiment may not be broken at the height of about 10 cm.

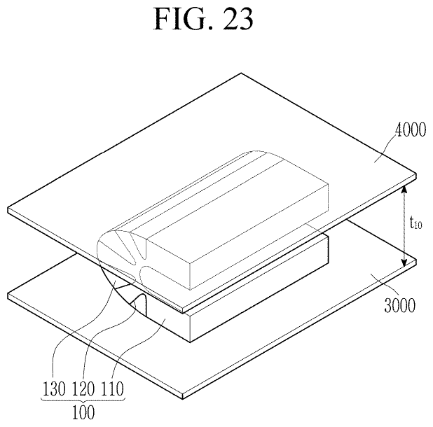

When the window 100 in the illustrated embodiment performs 2PB (2-Point Bending), and the distance is reduced by twice the thickness t₄ of the window 100+3 mm, it may not be broken. FIG. 23 shows a 2PB test. Referring to FIG. 23, the folded window 100 is disposed between the first substrate 3000 and the second substrate 4000, and the distance to between the first substrate 3000 and the second substrate 4000 is reduced, and the distance by which the window 100 is broken is measured. The window 100 may, as described above, include a body unit 110, a groove 120, and an elastic layer 130 filling the groove 120.

As the test result, it is found that when the distance t₁₀ between the first substrate 3000 and the second substrate 4000 is 3 mm+(2×t₄), the window 100 is not broken. Flexural intensity in this instance may be equal to or greater than about 1.5 gigapascals (GPa). Therefore, it is found that the window in the illustrated embodiment is folded up to the internal curvature level of 1.5R.

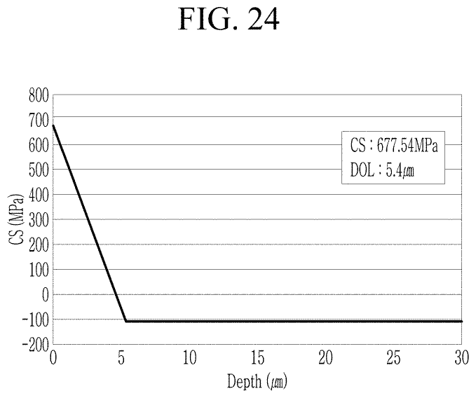

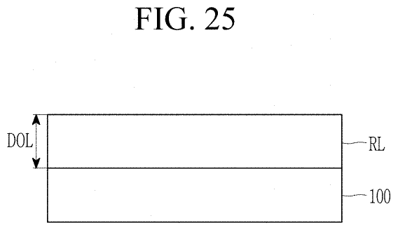

The window 100 may be chemically reinforced. The thickness DOL of the reinforced layer (refer to RL in FIG. 25) may be about 4 μm to about 80 μm. The compressed stress CS of the surface of the window 100 may be about 200 megapascals (MPa) to about 800 MPa. FIG. 24 shows compressed stresses with respect to thickness, regarding a window 100 with a thickness of a reinforced layer as about 5.4 μm and a compressed stress of a surface as about 677.54 MPa. Regarding the chemically reinforced window 100, the value of CT is calculated as compressed stress×reinforced layer thickness/(window thickness−2×reinforced layer thickness). (CT=CS×DOL/(t−2×DOL))

Folding tests for respective temperatures on the window in the illustrated embodiment are performed, and results are expressed in Table 1.

TABLE 1

| | | Estimation conditions |
|---|---|---|
| No | Estimation items | Folding |
| 1 | Room temperature 25° C. | 200,000 |
| 2 | High temperature 60° C. | 150,000 |
| 3 | Low temperature (−20° C.) | 30,000 |

As expressed in Table 1, no defects are generated at the folding of 200,000 times at 25 degrees Celsius (° C.), and no defects are generated at the folding of 150,000 times at 60° C. It is found that no defects are generated at the folding of 30,000 times at −20° C. Therefore, it is found that the window in the illustrated embodiment has excellent folding reliability, and no cracks, peeling off, or deformation are generated in various temperature environments.

Regarding the window 100 in the illustrated embodiment and the display device including the same, the groove 120 is defined in the window 100, and the size, the depth, and the gap of the groove 120 satisfy predetermined numerical values. The window 100 including the groove 120 satisfying the numerical values has excellent impact resistance.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

What is claimed is:

1. A window comprising:
a body unit in which a plurality of grooves is disposed,
wherein a width of a groove of the plurality of grooves in a first direction which is parallel to a main extension direction of the body unit is about 80 micrometers to about 100 micrometers.

2. The window of claim 1, wherein
a thickness of the body unit overlapping a lowest side of the groove in a second direction perpendicular to the first direction is about 25 micrometers to about 40 micrometers.

3. The window of claim 1, wherein
a ratio of a thickness of the body unit overlapping a lowest side of the groove to an entire thickness of the window is about 13 percent to about 50 percent.

4. The window of claim 1, wherein
a distance between adjacent grooves among the plurality of grooves in the first direction is about 100 micrometers to about 200 micrometers.

5. The window of claim 1, wherein
a compressed stress of a surface of the window is about 200 megapascals to about 800 megapascals when a reinforced layer having a thickness of about 4 micrometers to about 80 micrometers is disposed on the surface of the window.

6. The window of claim 1, wherein
the groove is defined in a first side of the body unit,
the groove is defined in a side which is compressed when bent, or
the groove is defined in a side which is tensioned when bent.

7. The window of claim 1, wherein
the plurality of grooves includes a first groove defined in a first side of the body unit, and a second groove defined in a second side of the body unit, and
the first groove and the second groove are alternately defined.

8. The window of claim 7, wherein
the first groove and the second groove have different widths in the first direction.

9. The window of claim 1, wherein
a width at an entrance of the groove in the first direction is less than a width in the groove in the first direction.

10. The window of claim 1, wherein
a width at an entrance of the groove in the first direction is greater than a width in the groove in the first direction.

11. A display device comprising:
a display panel including a bending area and a bending peripheral area; and
a window disposed on a first side of the display panel, the window comprising:
a body unit in which a plurality of grooves is defined,
wherein
a groove of the plurality of grooves is defined in the bending area, and
a width of the groove in a first direction which is parallel to a main extension direction of the body unit is about 80 micrometers to about 100 micrometers.

12. The display device of claim 11, wherein
a thickness of the body unit overlapping a lowest side of the groove in a second direction perpendicular to the first direction is about 25 micrometers to about 40 micrometers.

13. The display device of claim 11, wherein
a ratio of a thickness of the body unit overlapping a lowest side of the groove to an entire thickness of the window is about 13 percent to about 50 percent.

14. The display device of claim 11, wherein
a distance between adjacent grooves among the plurality of grooves in the first direction is about 100 micrometers to about 200 micrometers.

15. The display device of claim 11, further comprising:
a reinforced layer disposed on a surface of the window,
wherein
a thickness of the reinforced layer is about 4 micrometers to about 80 micrometers, and
a compressed stress of the side of the window is about 200 megapascals to about 800 megapascals.

16. The display device of claim 11, wherein
the groove is defined in a first side of the body unit,
the groove is defined in a side compressed when bent, or
the groove is defined in a side tensioned when bent.

17. The display device of claim 11, wherein
the plurality of grooves includes a first groove defined in a first side of the body unit, and a second groove defined in a second side of the body unit, and
the first groove and the second groove are alternately defined.

18. The display device of claim 11, wherein
a length of the bending area is greater than a product of pi (it) and a curvature radius of the display device by equal to or greater than 1 millimeter.

19. A method for manufacturing a window, the method comprising:
defining a groove by etching the window; and
additionally etching the window in which the groove is defined,
wherein a thickness of the window etched in the additionally etching is about 0.1 micrometer to about 5 micrometers.

20. The method of claim 19, wherein
a width of the groove in a first direction which is parallel to a main extension direction of the window is about 80 micrometers to about 100 micrometers.
